(19) United States
(12) Patent Application Publication
(10) Pub. No.: US 2018/0165746 A1
(43) Pub. Date: Jun. 14, 2018

(54) Network Interaction System

(71) Applicant: Alibaba Group Holding Limited, Grand Cayman, KY (US)

(72) Inventors: Pipei Huang, Hangzhou (CN); Peng Peng, Hangzhou (CN)

(21) Appl. No.: 15/836,690

(22) Filed: Dec. 8, 2017

(30) Foreign Application Priority Data
Dec. 9, 2016 (CN) 201611128672.6

(51) Int. Cl. G06Q 30/06; G06Q 30/02; G06F 17/30; H04L 29/08

(52) U.S. Cl. CPC G06Q 30/0631; G06Q 30/0282; H04L 67/306; G06F 17/30979; G06F 17/30991; G06Q 30/0643

(57) ABSTRACT

A network interaction system includes a front-end server and a recommendation system. The front-end server receives a search request from a client terminal, provides user information of the client terminal to the recommendation system, filters a result set from a content set provided by the recommendation system according to expected reward values provided by the recommendation system, and sends the result set to the client terminal. The recommendation system obtains a user feature set corresponding to the user information of the client terminal, obtains a content set including contents for displaying at pages and a content feature set corresponding to the contents, generates the expected reward values according to the user feature set and the content feature set. An expected reward value is a reward value obtained by the recommendation system when a corresponding content is displayed at a preset page and clicked.

### CROSS REFERENCE TO RELATED PATENT APPLICATIONS

This application claims priority to Chinese Patent Application No. 201611128672.6, filed on 9 Dec. 2016, entitled “Network Interaction System,” which is hereby incorporated by reference in its entirety.

### TECHNICAL FIELD

The present disclosure relates to the field of computer technology, and, more particularly, to a network interaction system.

### BACKGROUND

With the continuous development of e-commerce, more and more consumers are becoming accustomed to online shopping to enjoy the convenience from online shopping.

To satisfy the shopping demands from different users, the e-commerce websites are providing more and more products and services, such as electronics and furnishings. If “electronics” is used as a classification, there are many sub-classifications for different products, such as refrigerator, washer. Further, the product may be further classified into various brands and model numbers. The e-commerce website provides massive products and services.

When the user views the e-commerce website, the user needs to gradually find the desired product or service from the massive number of products and services provided by the e-commerce website. However, the current e-commerce website cannot efficiently provide the desired product or service to the user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure. The present disclosure provides a method and device for multi-display interaction, which makes the interaction process more vivid and real, which improves the user engagement.

The present disclosure provides a network interaction system, which includes a front-end server and a recommendation system. The front-end server receives a search request from a client terminal, receives user information of the client terminal, filters a result set from a content set according to expected reward values of contents in the content set obtained from the user information; and sends the result set to the client terminal. The recommendation system obtains a user feature set corresponding to the user information of the client terminal, obtains the content set including contents for displaying at pages and a content feature set corresponding to a content in the content set; and generates the expected reward value according to the user feature set and the content feature set. An expected reward value is a reward value obtained by the recommendation system when a corresponding content is displayed at a preset page and clicked. The content set and the expected reward values are provided to the front-end server.

The present disclosure provides an example method comprising: receiving a search request from a client terminal; receiving user information of the client terminal; filtering a result set from a content set according to expected reward values of contents in the content set obtained from the user information; and sending the result set to the client terminal. The expected reward values are generated by a recommendation system by acts including: obtaining a user feature set corresponding to the user information of the client terminal; obtaining the content set including contents for displaying at pages and a content feature set corresponding to a content in the content set; and generating the expected reward value according to the user feature set and the content feature set.

The present disclosure also provides an example server comprising: one or more processors; and one or more memories storing thereon computer-readable instructions that, when executed by the one or more processors, cause the one or more processors to perform acts comprising: receiving a search request from a client terminal; providing user information of the client terminal to a recommendation system; filtering a result set from a content set provided by the recommendation system according to expected reward values of contents in the content set; and sending the result set to the client terminal. The acts may further comprise: obtaining a user feature set corresponding to user information of the client terminal; obtaining a content set including contents for displaying at pages and a content feature set corresponding to a content in the content set; and generating an expected reward value according to the user feature set and the content feature set.

The present disclosure also provides one or more memories storing thereon computer-readable instructions that, when executed by the one or more processors, cause the one or more processors to perform acts comprising: obtaining a user feature set corresponding to user information of a client terminal; obtaining a content set including contents for displaying at pages and a content feature set corresponding to a content in the content set; generating an expected reward value for the content according to the user feature set and the content feature set; filtering a result set from the content set provided by the recommendation system according to expected reward values of contents in the content set; and sending the result set to a client terminal.

From the above technical solution provided by the present disclosure, the network interaction system provided by the present disclosure generates the expected reward values of the corresponding contents according to the user feature set of the identified user and the content feature set of the corresponding contents. Thus, the front-end server may selectively provide one or more contents from the content set to the user. In addition, the recommendation system may use the expected reward values to determine the probabilities that the user clicks the contents through data training so that the contents presented to the user have a high probability to attract the user's interest, thereby reducing the user's selection time and bringing convenience to the user.

### DRAWINGS

To more clearly illustrate the technical solutions in the example embodiments of the present disclosure, the drawings for illustrating the example embodiments are briefly introduced as follows. It is apparent that the FIGs only describe some of the embodiments of the present disclosure. One of ordinary skill in the art may obtain other figures according to the FIGs without using creative effort.

FIG. 1 is a diagram of an example network interaction system according to an example embodiment of the present disclosure;

FIG. 2 is a diagram of an example page that an example network interaction system provides to a client terminal according to an example embodiment of the present disclosure;

FIG. 3 is a flowchart of an example process that a user uses the client terminal to visit pages according to an example embodiment of the present disclosure;

FIG. 4 is a diagram of an example combination of a user feature set and a content feature set in a representative vector according to an example embodiment of the present disclosure; and

FIG. 5 is a diagram of an example process that the recommendation system calculates the indexes according to an example embodiment of the present disclosure;

### DETAILED DESCRIPTION

In conjunction with the following FIGs of the present disclosure, the technical solutions in the embodiments of the present disclosure will be clearly and completely described. Apparently, the described embodiments are merely some of the embodiments of the present disclosure and do not constitute limitation to the present disclosure. All other embodiments obtained by those of ordinary skill in the art based on the embodiments of the present disclosure fall within the scope of protection of the present disclosure.

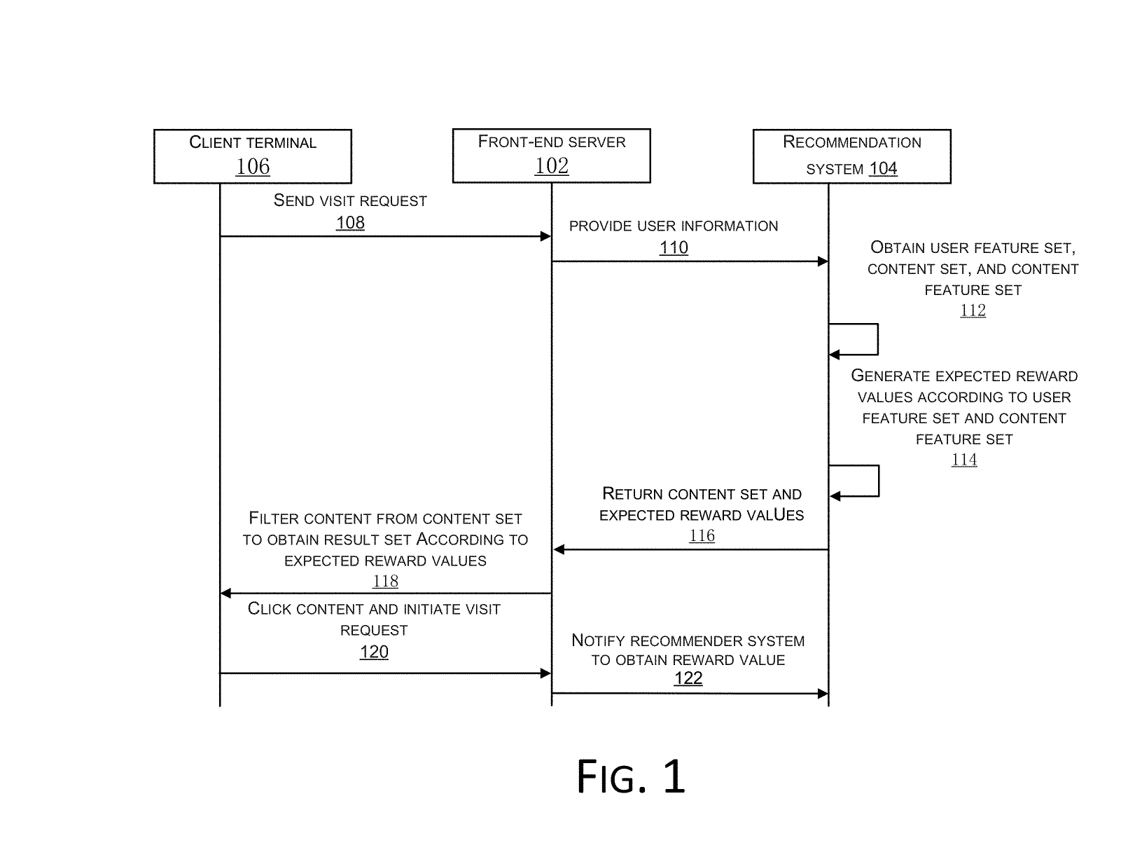

Referring to FIG. 1, the present disclosure provides an example network interaction system. The network interaction system includes a front-end server 102 and a recommendation system 104. The network interaction system communicates with a client terminal 106.

The front-end server 102, the recommendation system 104, and the client terminal 106 are computing devices, which may include one or more processors; and one or more memories storing thereon computer-readable instructions that, when executed by the one or more processors, cause the one or more processors to perform acts as described herein. The front-end server 102 and the recommendation system 104 may be separate computing device or integrated into one computing device.

The memory is an example of computer readable media. The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

At 108, the client terminal 106 sends a search request to the front-end server 102. At 110, the front-end server 102 provides user information to the recommendation system 104. At 112, the recommendation system 104 obtains a user feature set, a content set, and a content feature set. At 114, the recommendation system 104 generates the expected reward values according to the user feature set and the content feature set. At 116, the recommendation system 104 returns the content set and the expected reward values to the front-end server 102. At 118, the front-ender server 102 filters content from the content set provided by the recommendation system 104 to obtain a result set according to expected reward values provided by the recommendation system 104. The front-end server 102 sends the result set to the client terminal 106. At 120, the client terminal 106 clicks content and initiates the search request. At 122, the front-end server 102 notifies the recommendation system 104 to obtain the reward values.

For example, the front-end server 102 is an electronic device that has computing and network interaction capabilities or an application that is run on the electronic device to provide support for data processing and network interaction.

The present disclosure does not limit a quantity of the servers. The front-end server 102 may be one server or multiple servers, or a server set formed by multiple servers.

For example, the front-ender server may be a transaction server of an e-commerce website platform. The front-end server 102 may directly communicate with the client terminal 106 via a network.

For example, the client terminal 106 is an electronic device that has display, computing, and network access capabilities. For instance, the client terminal 106 may be a desktop, a tablet, a laptop, a smart phone, a portal digital assistant, a smart wearable device, a shopping terminal, or a TV with network access capability. Alternatively, the client terminal 106 is an application that is installed on the above electronic device. For example, the client terminal 106 may be a visit access provided by the e-commerce website platform, such as dangdang.com, amazon.com. The client terminal 106 may also be an application that is associated with the e-commerce website platform and runs on a smart phone, such as a mobile app for dangdang.com, a mobile app for amazon.com.

For example, the search request includes a character strings with a preset format, which represents a vising address of a page, such as a webpage. Alternatively, the search request includes a page identification that directs the search request to a particular page. The preset format is a format that follows network communication protocol so that the search request is transmitted via the Internet. For example, the client terminal 106 sends the search request to the front-end server 102 such as http, TCP/IP, or FTP protocol.

For example, the user information is information that identifies the client terminal 106. Alternatively, the user information is information that identifies a user that uses the client terminal 106. For example, user information is a preset name, a network address of the client terminal 106, or an identification assigned by the e-commerce website platform to the user. For instance, the user information is a user name for the user to log into the website.

For example, the methods that the front-end server 102 obtains the user information includes, but are not limited to, the following method. The search request of the client terminal 106 includes the user information. The front-end server 102 analyzes the search request to obtain the user information. The front-end server 102 searches for the user information in a database such as a locally stored database according to the search request of the client terminal 106. The search request is used to match the identification of the user information.

For example, the methods that the front-end server 102 filters a result set from a content set provided by the recommendation system 104 includes, but are not limited to, the following method. When the recommendation system 104 selects a preset quantity of contents from the content set to be provided to the client terminal 106, the recommendation system 104 may select from high to low according to the expected reward values of the corresponding contents in the content set. The front-end server 102 may also preset preferred categories of the contents, and select the contents by a combination of the categories of the contents and the expected reward values. For example, the content set provided by the recommendation system 104 includes a first content, a second content, and a third content, and their corresponding expected reward values are 0.5, 0.7, and 0.3 respectively. The front-end server 102 may provide the first content, the second content, and the third content to the client terminal 106. Alternatively, the front-end server 102 may rank the first content, the second content, and the third content to the client terminal 106 according to their corresponding expected reward values, and then provide the ranked contents to the client terminal 106. The front-end server 102 may select the first content and the second content whose expected reward values are higher than a preset value threshold or rankings are higher than a preset ranking threshold, and provide the first content and the second content to the client terminal 106. In an example scenario, the first content relates to electronic appliances, the second content relates to clothes, and the third content relates to firefighting products. The front-end server 102 sets that the firefighting products have priority and provide the third content having priority and the second content that has the highest expected reward value to the client terminal 106.

For example, the reward that the recommendation system obtains is based on the optimization goal. For instance, if the optimization goal is that the user purchases the recommended product, a positive reward is assigned to the recommendation system when the user makes purchases at the order page. For instance, the reward value may be the transaction amount of the purchased product. As the frequency of purchase is not high, in another example, a positive reward is assigned to the recommendation system when the user clicks the recommended content provided by the recommendation system. The techniques of the present disclosure also assign accumulative reward to the recommendation system to accumulate reward values within a preset time interval. A time efficient may be assigned to the reward values to make the recent reward values more valuable than future reward values.

The recommendation system 104 obtains a user feature set corresponding to the user information of the client terminal 106, obtains a content set including contents for displaying at pages and a content feature set corresponding to the contents, generates the expected reward values according to the user feature set and the content feature set. An expected reward value is a reward value obtained by the recommendation system 104 when a corresponding content is displayed at a preset page and clicked. The content set and the expected reward values are provided to the front-end server 102.

For example, the recommendation system 104 is one or more servers and the present disclosure does not limit a quantity of the servers. The recommendation system 104 may be one server or multiple servers, or a server set formed by multiple servers.

For example, the user feature set includes user attribute values in different dimensions. Thus, the user feature set may fully represent a user to predict the user behavior. For example, the user feature set includes, but is not limited to, an account name, gender, address, transaction information, page visit record at a designated time for a user. The recommendation system 104 stores the user feature set corresponding to the user information. The recommendation system 104 receives the user information, starts to collect the information, and forms the user feature set.

For example, the content set may include all data information of the e-commerce website platform. For another example, the content set may include a portion of all data information of the e-commerce website platform. Some preset rules may be set to filter from the data information of the e-commerce website platform to obtain the content set. For example, the content set may include at least two contents. For instance, the website platform is amazon.com, ebay.com, etc. For example, the contents include page contents and subject contents. The page contents are used to display one or more pages, such as a layer content and an object content. The object content is directed to a product or service provided at the website platform. For example, the layer content and the object content may include image, text, or video. The subject content is used to restrain the types of the page contents to be displayed. For example, the subject content is a category content. The category content restrains the categories of the object contents to be displayed at a specific location at the page. For example, the category content is small appliance. The object contents displayed at the location designated by the category content are images of the small appliance, such as razor, coffee machine.

For example, the content in the content set may also the page that displays the product or service. Alternatively, the content is a direction identification that is directed to the product or service. Alternatively, the page to which the content is directed refers to the page for a category of product or service that includes multiple products or service for the category. For example, if the content is electronics or car, the page to which the content is directed is a page for shopping electronics or a page for shopping cars respectively. The page for shopping electronics includes multiple electronic products. The page for shopping cars includes multiple models of cars.

For example, the content feature set includes content attribute values in different dimensions. The product or service to which the content is directed has its own attributes. The attribute values of these attributes together form the attribute feature set. Thus, the content feature set may fully represent a content. For example, the content feature set includes, but is not limited to, the attribute information such as the category, name, price, sale volume, review, purchase customers, suitable people, suitable season, listing time of the product or service.

For example, each content corresponds to a content feature set. Thus, the content feature set may be focus on the content and fully represent a content. For another example, multiple contents correspond to a content feature set to reduce a quantity of the content feature set and the storage space. For instance, multiple contents that are directed to the same or similar product or service may correspond to a content feature set.

Certainly, the contents of the content set and the content feature set are not restricted from the website platform. The content source of the content set and the content feature set may be also provided by a third party. For example, the third party may collect and organize data information from the network to form the content set and the content feature set. The third party provides the content set and the content feature set to the website platform to be stored at the website platform. The third party may also provide a visit access to the website platform to provide an index list to the website platform. Thus, the recommendation system 104 conducts searching to match according to the index list and retrieves data from the content set and the content feature set of the third party according to the index list. The third party may be a company specialized in data collecting, a website that tests the electronics professionally, or a merchant of the website platform.

For example, the recommendation system 104 generates the expect reward values corresponding to the contents. The expected reward values are the recommendation system 104's expectation of the reward values. After the content is displayed at the page, when the user clicks the content to send the search request to the front-end server 102, the reward value obtained by the recommendation system 104 is the expected reward value corresponding to the content. As the front-end server 102 filters the contents to provide to the client terminal 106 according to the expected reward values, the recommendation system 104 determines whether the use clicks the content corresponding to the maximum of expected reward values according to the obtained expected reward values. The recommendation system 104 further determines whether the generated expected reward value corresponding to the content is reasonable.

For example, the recommendation system 104 generates the expected reward value according to the user feature set and the content feature set of the content. Thus, the expected reward value reflects a probability that the user clicks the content to a certain extent when the content is displayed at the page. The higher the expected reward value the higher probability that the recommendation system 104 determines that user clicks the content. The lesser the expected reward value the lesser probability that the recommendation system 104 determines that user clicks the content. The recommendation system 104 generates the expected reward value according to a preset algorithm. For example, the recommendation system 104 uses the algorithm, such as the algorithm of reinforcement learning, and the user feature set and the content feature set as the input and outputs the expected reward value as the output.

For example, the reward is a value obtained by the recommendation system 104 when the content at the page is clicked. With respect to clicks to different contents, the values obtained by the recommendation system 104 are different. Thus, the recommendation system 104 obtains the maximum of the returned values. The obtained reward value is the highest expected reward value as a target of the recommendation system 104. The recommendation system 104 may revise its algorithm according to the obtained reward value and the expected reward value information of the content of the page to make the content displayed at the page more suitable to the user, and pursue the content corresponding to the highest expected reward value which is the interest or focus of the user.

After the content is displayed at the page, the user clicks the content to trigger the click event, which represents that the user needs to review a content detail page of the content. The client terminal 106 sends a search request to the front-end server 102. The search request directs to the content detail page of the content. After the front-end server 102 receives the search request, the front-end server 102 notifies the recommendation system 104 to obtain the reward value. The reward value is the expected reward value corresponding to the content. Thus, the operation behavior of the user is received from the page at the client terminal 106 and returned to the recommendation system 104. The recommendation system 104 further determines whether the expected reward value corresponding to the content is reasonable according to the returned reward value and whether to revise the algorithm. Thus, the self-learning of the recommendation system 104 is achieved.

The network interaction system provided by the present disclosure generates the expected reward values of the corresponding contents according to the user feature set of the identified user and the content feature set of the corresponding contents. Thus, the front-end server 102 may selectively provide one or more contents from the content set to the user. In addition, the recommendation system 104 may use the expected reward values to determine the probabilities that the user clicks the contents through data training so that the contents presented to the user have a high probability to attract the user's interest, thereby reducing the user's selection time and bringing convenience to the user.

In a specific example scenario, the user uses the client terminal 106 to visit the homepage of the website. The network interaction system of the website receives the search request sent by the client terminal 106. The front-end server 102, after receiving the search request, analyzes the search request to obtain user information identification such as “User ID 123” from the search request. The front-end server 102 provides the user information identification “User ID 123” to the recommendation system 104. The recommendation system 104 searches user information corresponding to the user information identification “User ID 123” from the stored user character set. For example, the user character set includes {user name: User ID 123, gender: female, age: 29, purchasing power: intermediate, . . . } In the example scenario, the page returned to the client terminal 106 may include three contents such as the layer content, the position content, and the object content. The layer content may be used as a container and include a layer subject. The layer content may include multiple position contents. The position content has the position subject. In the example scenario, there are four layer contents. The layer subject for each layer content may be different, such as smart appliance, home décor, underwear, and male and female shoes. Each layer content may have its corresponding content feature set. For example, the content feature set of the smart appliance layer includes {network: Wi-Fi, produce name: TV, product name: refrigerator, input method: touchscreen . . . }, which is not detailed herein. Similarly, the position content and the object content also have their corresponding content feature set, which are not detailed herein. In the example scenario, the recommendation system 104 obtains the content feature set corresponding to the layer content, and generates the expected reward value corresponding to the layer content based on the algorithm such as reinforcement learning algorithm according to the user feature set and the content feature set of the layer content. For example, the expected reward value of the smart appliance layer is 0.5, the expected reward value of the underwear layer is 0.3, the expected reward value of the home décor is 0.8, and the expected reward value of the male and female shoes is 0.6. Further, the recommendation system 104 calculates the expected reward for the position contents of each layer content.

The recommendation system 104 also calculates the expected reward values of the object contents.

In the example scenario, the recommendation system 104 provides the contents whose expected reward values are calculated and the expected reward values to the front-end server 102. The front-end server 102 ranks the layer contents based on the expected reward values of the layer contents. The front-end server 102 selects one or more position contents from the position contents corresponding to each layer content according to the expected reward values of the position contents. Each layer content may have multiple position contents. Only a portion of the position contents are displayed at a page display process. Thus, the front-end server 102 selects position contents with higher expected reward values. For example, the smart appliance layer displays 9 position contents. If there are 20 position contents corresponding to the smart appliance layer, the front server selects the top 9 position contents according to the expected reward values of the 20 position contents. Similarly, the front-end server 102 determines the object contents to be displayed at each position content according to the expected reward values of the object contents provided by the recommendation system 104.

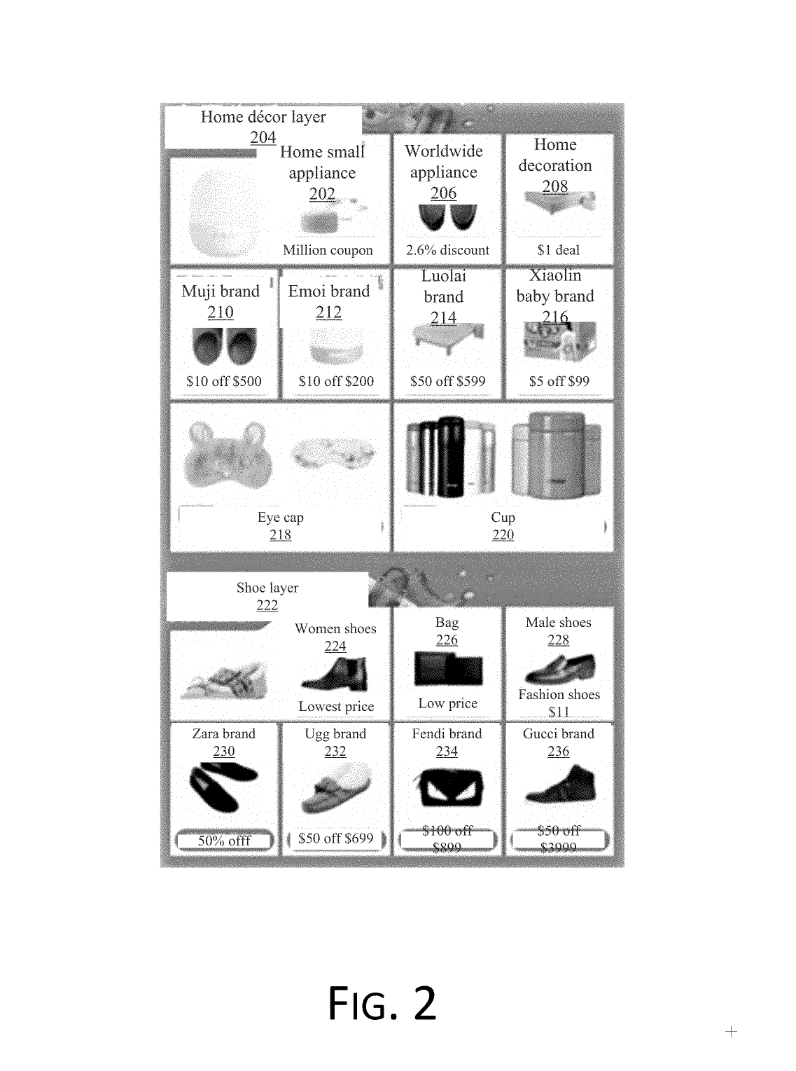

In the example scenario, referring to FIG. 2, the front-end server provides the contents after filtering to the client terminal. The client terminal displays an example page as shown in FIG. 2.

In the example scenario, the client terminal receives a click event that the user clicks the content of home small appliance 202 at the home decor layer 204. At the home décor layer 204, the page also includes other contents including worldwide appliance 206, home decoration 208, Muji brand 210, Emoi brand 212, Luolai brand 214, Xiaolin baby brand 216, eye cap 218, and cup 220.

In addition to the home décor layer 204, the page also includes the shoe layer 222. The shoe layer 222 includes the contents such as women shoes 224, bag 226, male shoes 228, Zara brand 230, Ugg brand 232, Fendi brand 234, Gucci brand 236.

The client terminal sends the search request to the network interaction system. The front-end server receives the search request, and provides the user information to the recommendation system. After the content of home small appliance is clicked, the recommendation system obtains the expected reward value of the content of home small appliance.

For example, the result set includes at least a content corresponding to the highest expected reward value.

When the front-end server filters the content set provided by the recommendation system, the front-end server places at least the content corresponding to the highest expected reward value into the result set. Thus, the page provided to the client terminal displays the content corresponding to the highest expected reward value. The content with the highest expected reward value, compared with other contents, is easier to attract the attention from the user so that the user further view the content detail page of the content after the content is clicked. From another aspect, the recommendation system considers the content corresponding to the highest expected reward value as the content that deserves the highest attention from the user. By presenting such content to the user, the recommendation system reduces the selection time of the user and brings convenience to the user.

For example, the expected reward value of the content in the result set is not smaller than the expected reward value of the content that is not in the result set and is in the content set provided by the recommendation system.

For example, the front-end server selects contents from the content set provided by the recommendation system according to their expected reward values and places them into the result set. The front-end server selects a preset quantity of contents, ranks the contents according to their expected reward values, and further selects the contents with relatively higher expected reward values. Further, the front-end server presets a threshold value and places the content whose expected reward value is higher than the threshold value into the result set.

For example, in the content set provided by the recommendation system, some contents are in the result set while some are not in the result set. The expected reward value of the content in the result set is not smaller than the expected reward value of the content that is not in the result set and is in the content set provided by the recommendation system. For example, the front-end server selects the preset quantity of contents. When there are multiple contents having the same expected reward value in the content set, after the selected content is placed in the result set, the expected reward value of a particular content in the result set is the same as certain content not in the result set. The expected reward value of the particular content in the result set is the same as that of certain content that is not placed into the result set. For example, the front-end server selects two contents to be placed into the result set. The content set includes a first content, a second content, and a third content, and their corresponding expected reward values are 0.7, 0.5, and 0.5 respectively. The expect reward values of the second content and the third content are same. The front-end server may randomly select one of the second content and the third content and place the selected content into the result set. The front-end server may also select one of the second content and the third content according to their default rankings and place the selected content into the result set.

For example, the recommendation system generates a representative vector of the corresponding content representing the user information and the content feature set according to the user feature set and the content feature set.

For example, the representative vector includes content attribute values of different dimensions. Based on the different value numbers of the attribute values, the user feature set and the content that is represented by each representative vector is also different. During the process of calculating the expected reward value, the calculation volume is reduced by inputting the representative vector to calculate the expected reward value of the content.

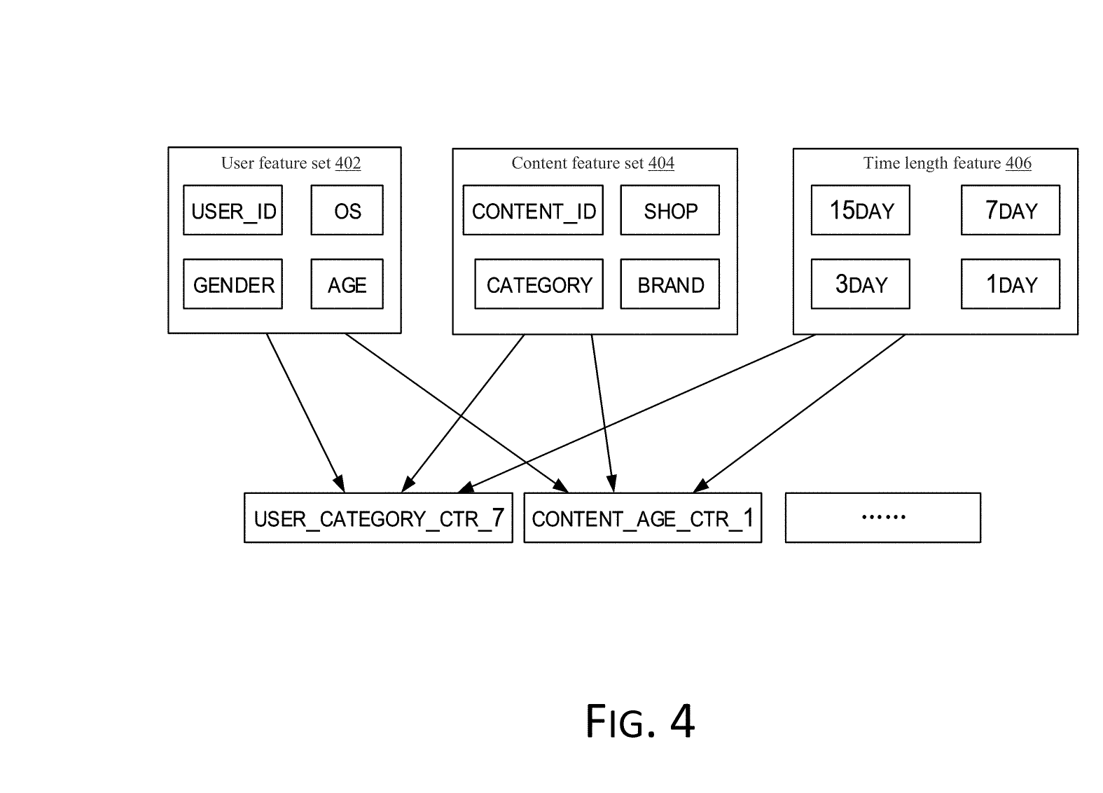

For example, the user feature set and the content feature set are calculated according to a preset algorithm to obtain the representative vector. A rule to generate the representative vector may be preset so that the representative vectors generated by the user feature set and different content feature sets have uniform standards. In the representative vector, there is at least one dimension, whose value represents a combination of certain features in the user feature set and the content feature set. For example, as shown in FIG. 4, the features such as the user id, age, gender, operation system of the user device in the user feature set 402, the features such as content id, shop, category, brand in the content feature set 404, and the time length features 406 such as 1 day, 3 days, 7 days, 15 days, have a cross combination to form a feature value of the representative vector. For example, the regression tree algorithm is applied to generate the representative vector based on the user feature set and the content feature set. For instance, the regression tree algorithm is GBDT (Gradient Boosting Decision Tree). The leaf node is used as the representative vector of the user feature set and the content feature set.

Certainly, the present disclosure only uses the regression tree algorithm as an example and is not restricted to the regression tree algorithm. For example, the representative vector is generated according to the user feature set and the content feature set by using the GBDT algorithm. The expected reward value of the corresponding content is generated based on the representative vector by using the reinforcement learning algorithm. The GBDT algorithm is used to organize the feature data to be as the input of the reinforcement algorithm, which simplifies the calculation process and improves the calculation efficiency. The polished representative vector more accurately represents the user and the content, which makes the expected reward value calculated through the reinforcement learning more accurate. Thus, the content provided by the front-end server to the user according to the expected reward value conforms with the user's interest more accurately.

In an example embodiment, the recommendation system accumulates the obtained reward values during the multiple search requests that the front-end server responds to the client terminal for an accumulated reward value. When the accumulated reward value is not the sum of the highest expected reward values of the contents in the result set from the above processes, the data that used to calculate the accumulate reward value is recorded as deviation information. The deviation information is used to revised the algorithm that generates the expected reward value.

For example, the accumulated reward value is the accumulation of the reward values obtained by the recommendation system from multiple page visits. The purpose pursed by the recommendation system is to make the accumulate reward value the sum of the highest expected reward values in the result set during the multiple page visits. That is, the recommendation system pursues maximization of the accumulated reward value. The recommendation system determines whether the expected reward value corresponding to the content is reasonable depending on whether the maximization of the accumulated reward value is obtained. The front-end server provides the content to the client terminal based on the corresponding expected reward value. If the expected reward value of the content is improper and the user does not click the content corresponding to the highest expected reward value, the reward value obtained by the recommendation system is not the highest expected reward value. If the accumulated reward value is the sum of the highest expected reward values in the result set during the multiple page visits, the content clicked by the user corresponds to the highest expect value during the multiple visits. Thus, the expected reward value generated by the recommendation system for the content is proper.

In the example embodiment, the recommendation system determines whether the current algorithm is reasonable depending on whether the accumulated reward value is equal to the sum of the highest expected reward values. The recommendation system thus has self-learning function, which reduces human participation and saves time and resources. The recommendation system automatically revises algorithm so that the recommendation system may quickly follow the actual visit situations of each user so that the page provided by the network interaction system conforms to the user's attention or interest point, which also saves the time that the user filters the content, reduces the operation that the user filters the content, and brings convenience to the user. Certainly, the present disclosure does not limit the automatic revision of algorithm to be done by the recommendation system. Alternatively, after the recommendation system records the deviation information, such deviation information is reviewed manually and the algorithm for the recommendation system is revised.

In this example embodiment, the recommendation system records the deviation information. Such deviation information is used as the basis to revise the algorithm for generating the expected reward value. The deviation information includes, but is not limited to, the user information, representative vector, user feature set, content feature set, expected reward value of the content, reward value obtained by the recommendation system, accumulated reward value, and the sum of highest expected reward value during multiple page visits.

In this example embodiment, the algorithm used by the recommendation system to generate the expected reward value has multiple parameters. The revision to the algorithm may include revision of some parameter values of the algorithm so that the content actually clicked by the user has highest expected reward value in its result set. In general, if the user clicks the content, such action indicates that the content that the user actually pays attention or is interested. Based on such assumption, the network interaction system revises the algorithm for generating the expected reward value so that the actually clicked content has the highest expected reward value and the algorithm more actually matches the content that the user is interested or pays attention. In the user's subsequent visits to the page, the network interaction system more accurately provides the content that the user is interested or pays attention to reduce the user's filtering time.

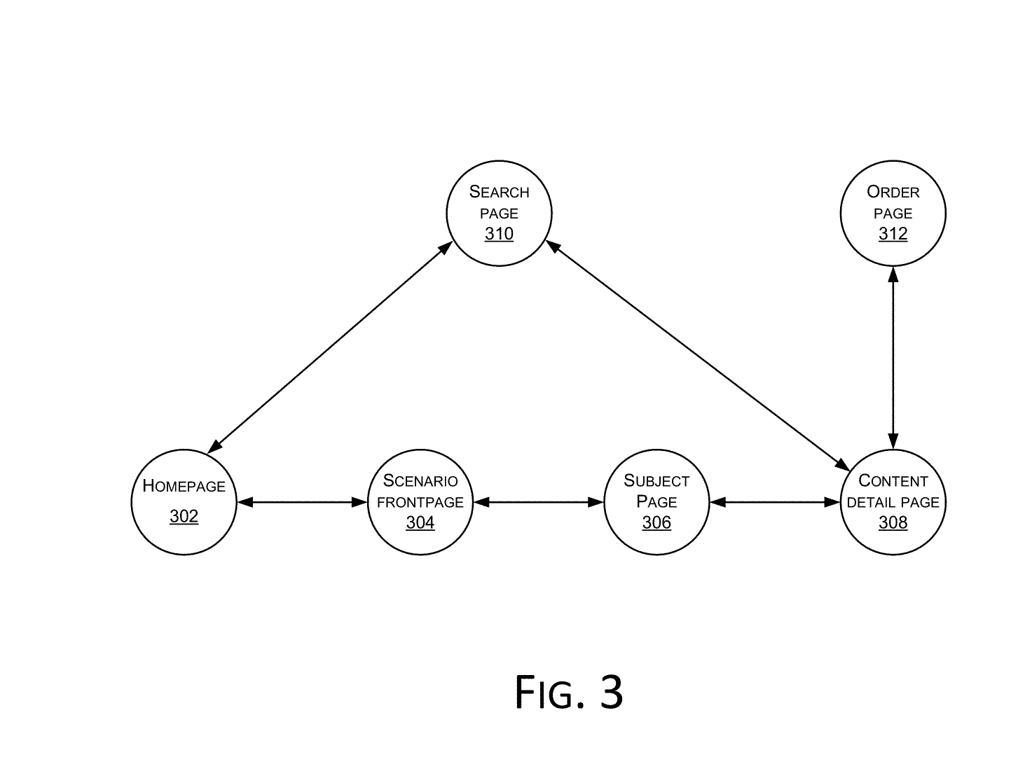

In an example scenario, referring to FIG. 3, after the client terminal displays the homepage 302 of the website, the next step operation is performed. The arrows between the homepage 302, scenario frontpage 304, subject page 306, content detail page 308, search page 310, order page 312 indicate that they are switched between each other according to the user's visiting behavior. After the user clicks the content representing the scenario frontpage 304? at the homepage 302?, the client terminal sends a search request for the scenario frontpage 304 to the network interaction system. At that time, the recommendation system obtains the reward value, which is expected reward value of the content that has the click event occurred. For example, the expected reward value is 0.7. According to the above description, the network interaction system provides the scenario frontpage to the client terminal. For example, the scenario frontpage has a few products with different subjects. When the user clicks a particular product with a particular subject, such action indicates that the user clicks the content corresponding to the particular product. The client terminal sends the search request for the subject page to the network interaction system. At that time, the recommendation system obtains the reward value, which is expected reward value of the content at the scenario frontpage that has the click event occurred. For example, the expected reward value is 0.6. At that time, the accumulated reward value obtained by the recommendation system is 1.3. Such process continues until when the user visits the order page and place order information. During the process, if each time the content clicked by the user is the content corresponding to the highest expected reward value at a corresponding page, the accumulated reward value obtained by the recommendation system is the sum of highest expected reward values. This is the target of the recommendation system. If, at the scenario frontpage, the content clicked by the user is not the content corresponding to the highest expected reward value at such page, the accumulated reward value obtained by the recommendation system is not the sum of highest expected reward values. For example, the highest expected reward value at the scenario frontpage is 0.9 and its corresponding content is the content with the subject of business watch. The actual content clicked by the user is the content with the subject of casual shoes, which makes the reward value obtained by the recommendation system is the reward value corresponding to the content with the casual shoe subject, which is 0.6. At that time, the accumulated reward value obtained by the recommendation system is 1.3, which is smaller than the sum of the highest expected reward values, which is 1.5. Thus, the recommendation from the recommendation system is considered improper and such deviation information is recorded as the basis for the following revision.

In an example embodiment, when the front-end server receives the order information sent by the client terminal, the recommendation system determines whether the accumulated reward value is the sum of the highest expected reward values in the result set during the process of multiple search requests by the client terminal.

In the example embodiment, the recommendation system treats the multiple page visits, as a whole, from the time that the client terminal visits the homepage of the website to the time that the client terminal finally makes the order to calculate the accumulated reward value. The recommendation system determines whether the accumulated reward value, prior to making order, is the sum of the highest expected reward values of the contents provided to the client terminal in the result set.

In the example embodiment, the final target of the network interaction system is the order information sent by the client terminal. If the content clicked by the user each time is the content having the highest expected reward value, such click path is deemed a shortest path from the time that the client terminal firstly visits the page to the time that the client terminal submits the order information. Thus, the user uses relatively less operations and less time. As the operation by each user is reduced, the work volume between the network interaction system and the client terminal is reduced. When the transaction loading capability of the network interaction system is limited, the techniques of the present disclosure make the network interaction system serve more client terminals.

In an example embodiment, when the click event occurs at the preset page, if the obtained reward value is not the highest expected reward value of the content in the result set, the deviation information is recorded. The deviation information includes the information of the content corresponding to the reward value. The algorithm for generating the expected reward value is revised according to the deviation information.

In the example embodiment, the target of the recommendation system is to obtain the highest reward value. That is, the purpose pursed by the recommendation system is that the obtained reward value is the highest expected reward value of the content in the result set. When the reward value obtained by the recommendation system is not the highest expected reward value of the content in the result set, the expected reward value that the recommendation system generates for the content is improper. The recommendation system may revise its algorithm for generating the expected reward value so that the content corresponding to the highest expected reward value conforms to the interest or focus of the user more accurately. Thus, the content corresponding to the highest expected reward value is clicked by the user. The reward value obtained by the recommendation system is the highest expected reward value of the content in the result set.

In an example embodiment, the recommendation system revises the algorithm according to the deviation information recorded in a preset time length.

In this example embodiment, the recommendation system does not immediately review the algorithm based on the recorded deviation information. The recommendation system may use the recorded deviation information within a preset time length as an input to revise the recommendation system. Thus, the techniques of the present disclosure avoid that the reward value received by the recommendation system is not the above described highest expected reward value due to the errors of the operations of the user. The revision to the algorithm becomes more reasonable. For example, the present time length is 1 hour, 3 hours, 1 day, 2 days, 1 month, etc., which is not listed herein.

In an example embodiment, the recommendation system revises the algorithm according to the deviation information when the deviation information reaches a preset data volume.

For example, the present data volume is a specific number. The present data volume may refer to a number of times that the reward value obtained by the recommendation system is different from the highest expected reward value. Alternatively, the present data volume may refer to a number of times that the accumulated reward value obtained by the recommendation system is different from the sum of the highest expected reward values in the corresponding process.

In this example embodiment the recommendation system does not immediately review the algorithm based on the recorded deviation information. Thus, the techniques of the present disclosure avoid immediately revising the algorithm for generating the expected reward value due to the errors of the operations of the user so that the content with less expected reward value in the result set provided to the user conforms the interest or attention of the user.

In an example embodiment of the present disclosure, the recommendation system includes at least two expected reward value calculation models. The at least two expected reward value calculation models have similar calculation logics. However, the training data sets for generating the at least two expected reward value calculation models are different.

In the example embodiment, the expected reward value calculation model may be obtained based on the training of the historical data of the website platform and output the expected reward value of the content based on the input user feature set and the content feature set. For example, the expected reward value calculation model is generated based on the reinforcement algorithm.

For example, the training data set includes the historical data of the website platform. The historical data may be the log data of the website platform, which includes the content, content feature, user information, user visit information, user feature set, etc. at the website platform.

In the example embodiment, the similar calculation logic is that the at least two expected reward value calculation models have the same algorithm basis. For example, the at least two expected reward value calculation models are both based on the reinforcement algorithm. As different training data sets are used, the internal parameters for calculation during the formation of the at least two expected reward value calculation models are different.

For example, the training data sets of the at least two expected reward value calculation models are different, which are the log data recorded by the website platform in different time periods. For instance, the calculation model generated based on the reinforcement learning algorithm firstly uses the log data of the website platform from Nov. 21, 2015 to Nov. 25, 2015 and the calculation model obtained from the training is used as the first calculation model. Then the log data from Nov. 26, 2015 to Nov. 31, 2015 is used to train the first calculation model to obtain the second calculation model. Thus, the first calculation model and the second calculation model have similar calculation logics but use different training data sets.

In an example embodiment, the expected reward value is a weighted average value or mean average value of the predicted values output by the at least two expected reward value calculation models.

In this example embodiment, the finally output expected reward value is the output result of the two at least two expected reward value calculation models through calculation. Each expected reward value calculation model outputs a predicted value. The predicted values output by the at least two expected reward value calculation models are summed and used to calculate the average value. The average value is used as the finally output expected reward value. Certainly, during the process of forming the at least two expected reward value calculation models, a weight may be assigned to each expected reward calculation model. When the final expected reward value is generated, the predict value output by each expected reward value calculation model is used to calculate the weighted sum, and the weighted sum value is used as the final expected reward value. For example, the adaptive online learning algorithm is used to set the weight for the calculation model obtained from the training. This example embodiment uses the collaboration of multiple expected reward calculation models to obtain the final expected reward value so that the recommendation system has better adaptability to different businesses, scenarios, and user groups.

For example, the following formula is used to represent the expected reward value:

Q(s,a)= [symbol] [R|s,a]

Q represents the expected reward value; s represents the user feature set; a represents the list of contents that the recommendation system provides to the user represented by s; R represents the reward value that is predicted to be obtained by the recommendation system when the click event occurs at the client terminal after the content is provided to the client terminal; E represents a function to obtain the expected reward value. The function may be a linear function or neural network.

The above formula is suitable for recommending single content. In some scenarios, multiple contents need to be recommended simultaneously. The present disclosure also provides an example algorithm for recommending multiple contents. Assuming that the user likes the product A and the user will not give up clicking the product A if he/she finds more favorable product B in the same recommendation list, the calculation of the accumulated reward for presenting each product is independent. A following function to recommend multiple contents may be deduced to simply the calculation process and reduce the workload of hardware

$$f ( s , i ) = I ( {s}_{i} ) [ {r}_{i} + γ {\sum }_{j ∈ {a}_{i}}^{ } f ( {s}_{i} , j ) ]$$

f(s,i) represents an estimate of the true value Q(s,i); i represents a content serial number; rᵢ represents the reward value obtained by the recommendation system when the user clicks the content i; γ represents an attenuation coefficient; αᵢ represents a list that the recommendation system provides to the user after the user clicks the content i; and j represents a content in the recommended content list αᵢ.

As shown from the above technical solutions provided by the example embodiment of the present disclosure, the network interaction system provided by the present disclosure provides the page data with respect to the search request provided by the client terminal. The content in the page data corresponds to an expected reward value. When the content is clicked, the recommendation system obtains the reward value. The reward value is equal to the expected reward value of the content. Thus, the recommendation system is designed to obtain the largest reward value as the target of the system design so that the content provided by the network interaction system to the user attracts the user's interest or attention for the user to click and visit, which reduces the filtering time by the user. In addition, the techniques of the present disclosure also reduce the works for the user to filter many webpages, which reduces the workload of the network interaction system. Under the limited capacity of the network interaction system, the workload to respond to the single user is reduced and thus the network interaction system is able to provide services to more users.

The present disclosure also provides a network interaction system. The network interaction system includes a front-end server and a recommendation system.

The front-ender server receives a search request from a client terminal, provides user information of the client terminal to the recommendation system, filters a result set from a content set provided by the recommendation system according to the index volume provided by the recommendation system, and sends the result set to the client terminal. The result set includes at least one contents.

The recommendation system obtains a user feature set corresponding to the user information of the client terminal, obtains a content set including contents for displaying at pages and a content feature set corresponding to the contents, generates the representative vector representing the user information and the content according to the user feature set and the content feature set, obtains the index volume of the content corresponding to the user information based on the representative vector, and provides the content set and the index volume to the front-end server.

For example, the index volume is a specific number.

The front-end server filters the contents in the content set according to the index volume.

For example, the index volume is a predict value of the click rate.

The front-end server returns the content to the client terminal according to the predicted click rate so that the content displayed at the client terminal has a high probability to be visited by the user.

For example, the algorithm that the recommendation system generates the index volume based on the representative vector may be FTRL algorithm (Follow the regularized leader) or LR algorithm (logistic regression).

For example, recommendation system generates the representative vector representing the user and the content according to the user feature set and the content feature set.

In the representative vector, there is at least one dimension, whose value represents a combination of certain features in the user feature set and the content feature set.

For example, as shown in FIG. 4, the features such as the user ID, age in the user feature set 402 and the features such as the content ID, category in the content feature set 404 have a cross combination to form a feature value of the representative vector.

For example, the GBDT algorithm is used to combine the user feature set and the content feature set to form the representative vector.

The present disclosure also provides another example network interaction system.

The network interaction system includes a front-end server and a recommendation system.

The front-ender server receives a search request from a client terminal, provides user information of the client terminal to the recommendation system, filters a result set from a content set provided by the recommendation system according to the index volume provided by the recommendation system, and sends the result set to the client terminal. The result set includes at least one contents.

The recommendation system obtains a user feature set corresponding to the user information of the client terminal, obtains a content set including contents for displaying at pages and a content feature set corresponding to the contents. The recommendation system also classifies the features in the user feature set and the content feature set into discreet feature set and continuous feature set, and obtains the index volume of the content corresponding to the user information according to the discrete feature set and continuous feature set. The recommendation system provides the content set and the index volume to the front-end server.

In the example embodiment, the features included in the discrete feature set includes features that are independent to each other. Each feature included in the discrete feature set represents an attribute of a dimension. For example, the discrete feature set includes the feature that is used as the identification. That is, the feature may identify an object or a transaction. For example, the discrete feature set includes the user name, network address of the client terminal, physical address of the client terminal, webpage identification, advertisement position identification, session identification, and so on.

In the example embodiment, the features in the continuous feature set represent a continuous status or data that are collected or calculated within a preset period of time. For example, the features in the continuous feature set represent the status, frequency, and process of the object or data. For instance, the continuous feature set includes the click rate, sales volume, payment percentage, review information, etc.

In the example embodiment, when the index volume corresponding to the content is calculated, the content feature set of the content and the user feature set are classified into the continuous feature set and the discrete feature set. When multiple contents are involved, the operation of classifying the discrete feature set and the continuous feature set are conducted to each content.

For example, the index volume is a specific number. The front-end server filters the contents in the content set according to the index volume. For example, the index volume is a predict value of the click rate. The front-end server returns the content to the client terminal according to the predicted click rate so that the content displayed at the client terminal has a high probability to be visited by the user.

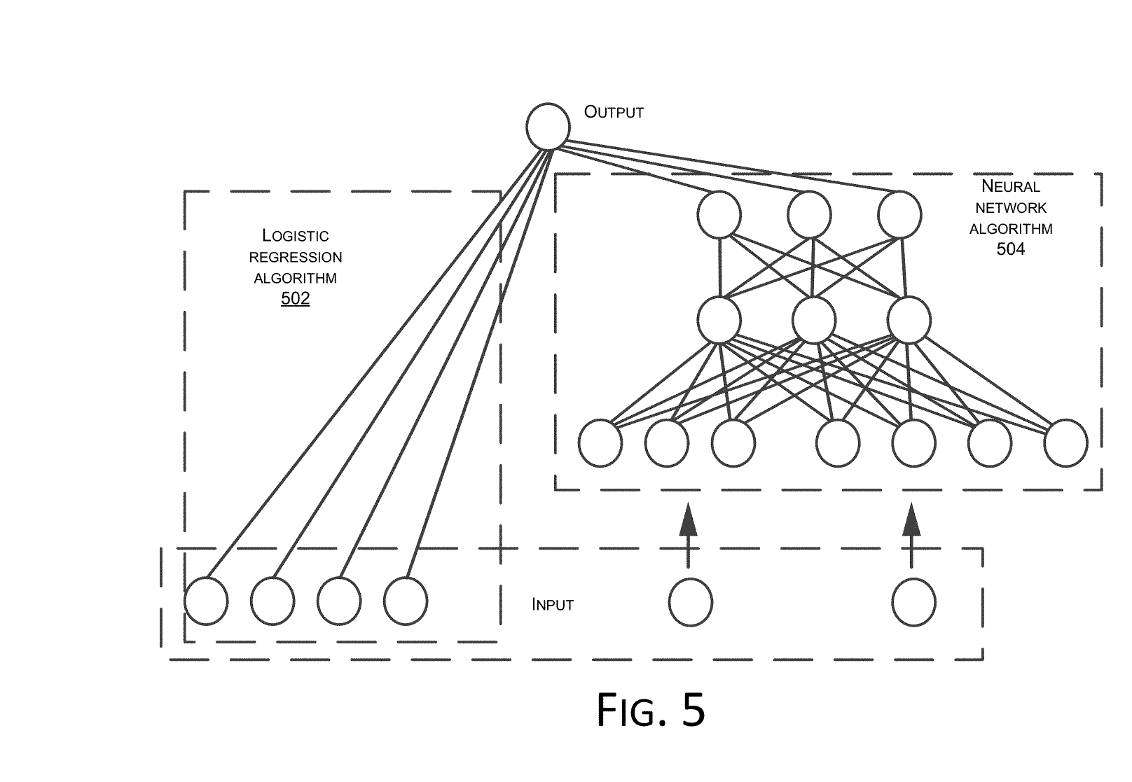

In an example scenario, referring to FIG. 5, the recommendation system applies the logistic regression algorithm 502 to some features in the discrete feature set and the continuous feature set for calculation, and applies the neural network algorithm 504 to some features in the discrete feature set and the continuous feature set for calculation. The outputs from the applying of the logistics regression algorithm and the neural network algorithm are integrated and processed to obtain the final index volume according to certain algorithm. The neural network algorithm includes, but is not limited to, the convolutional neural network algorithm, recurrent neural network algorithm, and deep neural network algorithm. The discrete feature set and the continuous feature set are used as the input to the logistic regression algorithm and the neural network algorithm respectively. Alternatively, the discrete feature set and the continuous feature set are commingled and some of the features are used as input to the logistic regression algorithm and the neural network algorithm. For example, the recommendation system integrates the output of the logistic regression algorithm and the neural network algorithm according to the wide & deep learning (WDL) algorithm. An example algorithm is as follows:

P(Y=1|x)=σw_{wide}^{T}[x,ϕ(x)]+w_{deep}^{T}α^{(lf)}+b)

P represents a predicted click rate; Y represents a label; σ represents an activation function; W_{wide} represents the logistic regression algorithm; W_{deep} represents the neural network algorithm; X represents the original sample feature; b represents a bias item; Φ represents a cross multiplication operation (Φ(x) represents the feature that is obtained after the original sample feature vector are cross multiplied), α^{(lf)} represents an output of the hidden layer of the neural network.

In an example embodiment, the recommendation system includes at least two index volume calculation models. In an example embodiment of the present disclosure, the at least two index volume calculation models have similar calculation logics. However, the training data sets for generating the at least two index volume calculation models are different.

In the example embodiment, the index volume calculation model may be obtained based on the training of the historical data of the website platform and output the index volume of the content based on the input user feature set and the content feature set. For example, the index volume calculation model is based on the FTRL algorithm or the WDL algorithm.

For example, the training data set includes the historical data at the website platform. The historical data may be the log data of the website platform, which includes the content, content feature, user information, user visit information, user feature set, etc. at the website platform.

In the example embodiment, the similar calculation logic is that the at least two index volume calculation models have the same algorithm basis. For example, the at least two index volume calculation models are based on the FTRL algorithm or the WDL algorithm. As different training data sets are used, the internal parameters for calculation during the formation of the at least two index volume calculation models are different.

For example, the training data sets of the at least two index volume calculation models are different, which are the log data recorded by the website platform in different time periods. For instance, the calculation model generated based on the FTRL algorithm or the WDL algorithm firstly uses the log data of the website platform from Nov. 21, 2015 to Nov. 25, 2015 and the calculation model obtained from the training is used as the first calculation model. Then the log data from Nov. 26, 2015 to Nov. 31, 2015 is used to train the first calculation model to obtain the second calculation model. Thus, the first calculation model and the second calculation model have similar calculation logics but use different training data sets.

In an example embodiment, multiple network interaction systems provided by the present disclosure may be combined. For example, the front-end server is used to filter contents according to the expected reward values of the contents provided by the recommendation system or according to the index volumes of the contents provided by the recommendation system. Thus, the multiple recommendation systems provided by the example embodiment of the present disclosure may have a parallel relationship. The front-end server, after receiving the search request, selects a recommendation system to respond and work according to a present rule. For example, the front server, after receiving the search request of the client terminal, randomly selects a recommendation system, such as the above described recommendation system that provides the expected reward value, to provide the user information to the recommendation system. Alternatively, the front-end server sets a corresponding relationship between the user information and the recommendation system. That is, a mapping rule between the user and the recommendation system is preset. After the receiving the search request, the front-end server calls the recommendation system according to the corresponding relationship.

Each of the example embodiments in the present disclosure is described in a progressive manner, and the same or similar parts are referenced to each other. Each example embodiment focuses on the differences from the other example embodiments.

The server described in the present disclosure is an electronic device with calculation and processing capability. The server may include the network communication interface, memory, and processor. Certainly, the server may alternatively be an application that is installed on the above electronic device. The server may be a distributive server, which is a system that includes multiple processors, memories, and network communication interfaces that collaborate with each other.

Although the present disclosure describes by reference to the example embodiments, one of ordinary skill in the art would understand that the present disclosure may have many modifications and variations that do not depart from the spirits of the present disclosure. The appended claims include those modification and variations without departing from the spirits of the present disclosure.

The present disclosure may further be understood with clauses as follows.

Clause 1: A network interaction system comprising: a front-end server and a recommendation system, wherein: the front-ender server receives a search request from a client terminal, provides user information of the client terminal to the recommendation system, filters a result set from a content set provided by the recommendation system according to expected reward values provided by the recommendation system, and sends the result set to the client terminal; and the recommendation system obtains a user feature set corresponding to user information of the client terminal, obtains a content set including contents for displaying at pages and a content feature set corresponding to the contents, generates an expected reward value according to the user feature set and the content feature set, wherein the expected reward value is a reward value obtained by the recommendation system when the content is displayed at a preset page and clicked, and provides the content set and the expected reward values to the front-end server.

Clause 2: The system of clause 1, wherein the result set includes at least a content corresponding to a highest expected reward value.

Clause 3: The system of clause 1, wherein: the result set includes a preset number of contents; and the expected reward value of the contents in the result set are not smaller than an expected reward value of a content that is not in the result set and is in the content set provided by the recommendation system.

Clause 4: The system of clause 1, wherein the recommendation system generates a representative vector of the corresponding content representing the user information and the content feature set according to the user feature set and the content feature set.

Clause 5: The system of clause 1, wherein the recommendation system accumulates obtained reward values during multiple search requests that the front-end server responds to the client terminal for an accumulated reward value; when the accumulated reward value is not a sum of highest expected reward values of the contents in the result set from the multiple search requests, records data that used to calculate the accumulate reward value as deviation information; and revises an algorithm that generates the expected reward values according to the deviation information.

Clause 6: The system of clause 5, wherein: when the front-end server receives order information sent by the client terminal, the recommendation system determines whether the accumulated reward value is the sum of the highest expected reward values in the result set during the multiple search requests requested by the client terminal.

Clause 7: The system of clause 1, wherein: when a click event occurs at a preset page, in response to determining that obtained reward value is not a highest expected reward value of a content in the result set, the recommendation system records the deviation information, the deviation information including information of the content corresponding to the reward value, and revises an algorithm for generating the expected reward value according to the deviation information.

Clause 8: The system of clause 5 or 7, wherein the recommendation system revises the algorithm according to the deviation information recorded within a preset time length.

Clause 9: The system of clause 5 or 7, wherein the recommendation system revises the algorithm according to the deviation information when the deviation information reaches a preset data volume.

Clause 10: The system of clause 1, wherein the recommendation system includes at least two expected reward value calculation models, the at least two expected reward value calculation models having similar calculation logics and different training data sets for generating the at least two expected reward value calculation models.

Clause 11: The system of clause 10, wherein the expected reward value is a weighted sum or a mean average value of predicted values output by the at least two expected reward value calculation models.

What is claimed is:

1. A method comprising:
receiving a search request from a client terminal;
receiving user information of the client terminal;
filtering a result set from a content set according to expected reward values of contents in the content set obtained from the user information; and
sending the result set to the client terminal.

2. The method of claim 1, wherein the expected reward values are generated by a recommendation system that performs acts including:
obtaining a user feature set corresponding to the user information of the client terminal;
obtaining the content set including contents for displaying at pages and a content feature set corresponding to a content in the content set; and
generating the expected reward value according to the user feature set and the content feature set.

3. The method of claim 2, wherein:
the expected reward value is an assigned reward value when the content is displayed at a preset page and clicked.

4. The method of claim 2, wherein the result set includes at least a content corresponding to a highest expected reward value.

5. The method of claim 2, wherein:
the result set includes a preset number of contents; and
an expected reward value of a content in the result set is not smaller than an expected reward value of a content that is not in the result set and is in the content set.

6. The method of claim 2, wherein the acts further include:
generating a representative vector of a corresponding content representing the user information and the content feature set according to the user feature set and the content feature set; and
generating the expected reward value based on the representative vector.

7. The method of claim 1, further comprising:
accumulating obtained expected reward values during multiple search requests to obtain an accumulated expected reward value; and
in response to determining that the accumulated expected reward value does not equal to a sum of highest expected reward values of contents in the result set from the multiple search requests, recording data that used to calculate the accumulate expected reward value as deviation information.

8. The method of claim 7, further comprising:
revising an algorithm that generates the expected reward values according to the deviation information.

9. The method of claim 8, wherein the revising the algorithm includes revising the algorithm according to the deviation information recorded within a preset time length.

10. The method of claim 8, wherein the revising the algorithm includes revising the algorithm according to the deviation information when the deviation information reaches a preset data volume.

11. The method of claim 2, wherein the expected reward value is generated by:
using at least two expected reward value calculation models to generate the expected reward value,
wherein the at least two expected reward value calculation models have similar calculation logics and different training data sets for generating the at least two expected reward value calculation models.

12. The method of claim 2, wherein the expected reward value is a weighted sum or a mean average value of predicted values output by the at least two expected reward value calculation models.

13. A server comprising:
a front-end server configured to to perform acts comprising:
receiving a visit search request from a client terminal;
providing receiving user information of the client terminal to a recommendation system;
filtering a result set from a content set provided by the recommendation system according to expected reward values of contents in the content set obtained from the user information; and
sending the result set to the client terminal.

14. The server of claim 13, wherein the server further comprising a recommendation system configured to perform operations comprising:
obtaining a user feature set corresponding to the user information of the client terminal;
obtaining the content set including contents for displaying at pages and a content feature set corresponding to a content in the content set; and
generating the expected reward value according to the user feature set and the content feature set.

15. The server of claim 14, wherein:
the expected reward value is an assigned reward value when the content is displayed at a preset page and clicked.

16. The server of claim 14, wherein the result set includes at least a content corresponding to a highest expected reward value.

17. The server of claim 14, wherein:
the result set includes a preset number of contents; and
an expected reward value of a content in the result set is not smaller than an expected reward value of a content that is not in the result set and is in the content set.

18. The server of claim 14, wherein the operations further comprise:
generating a representative vector of a corresponding content representing the user information and the content feature set according to the user feature set and the content feature set; and
generating the expected reward value based on the representative vector.

19. The server of claim 13, wherein the acts further comprise:
accumulating obtained expected reward values during multiple search requests to obtain an accumulated expected reward value; and
in response to determining that the accumulated expected reward value does not equal to a sum of highest expected reward values of contents in the result set from the multiple search requests, recording data that used to calculate the accumulate expected reward value as deviation information.

20. One or more memories storing thereon computer-readable instructions that, when executed by the one or more processors, cause the one or more processors to perform acts comprising:
obtaining a user feature set corresponding to user information of a client terminal;
obtaining a content set including contents for displaying at pages and a content feature set corresponding to a content in the content set;
generating an expected reward value for the content according to the user feature set and the content feature set;
filtering a result set from the content set provided by the recommendation system according to expected reward values of contents in the content set; and
sending the result set to a client terminal.
